(19) United States
(12) Patent Application Publication
(10) Pub. No.: US 2026/0111190 A1
(43) Pub. Date: Apr. 23, 2026

(54) Method and Device for Memory Planning for a Code Generation for a Program Code for Calculating an Artificial Neural Network in a Hardware Environment

(71) Applicant: Robert Bosch GmbH, Stuttgart (DE)

(72) Inventors: Benjamin Wagner, Friedrichshafen (DE); Duy Khoi Vo, Waiblingen (DE); Leif Sulaiman, Lund (SE); Markus Lochmann, Reutlingen (DE); Sebastian Boblest, Duernau (DE); Ulrik Hjort, Malmö (SE)

(21) Appl. No.: 19/360,220

(22) Filed: Oct. 16, 2025

(30) Foreign Application Priority Data
Oct. 18, 2024 (EP) 24207524.0

(51) Int. Cl. G06F 8/35

(52) U.S. Cl. CPC G06F 8/35

(57) ABSTRACT

A computer-implemented method for performing memory planning for a code generation for determining a code for computing a neural network includes (i) providing successive calculation steps of the neural network, wherein for each calculation step the size of an input data block and an output data block is determined, (ii) determining a condition for the memory planning for each specific computing step, in which an input data block in a memory area is at least partially contained in the output data block, wherein the condition indicates that the memory area associated with the output data block of the calculation step preceding the specific calculation step is contained in the memory area of the output data block of the specific calculation step, and (iii) performing memory planning in which the memory area of the respective input data block and output data block in the working memory is determined for each calculation step, taking into account the determined conditions.

This application claims priority under 35 U.S.C. § 119 to patent application no. EP 24207524.0, filed on Oct. 18, 2024 in the European Patent Office, the disclosure of which is incorporated herein by reference in its entirety.

The disclosure relates to the implementation of a program code on a hardware environment, such as that occurring as microcontroller-controlled control devices and the like. The disclosure further relates to methods for memory planning for handling input data, output data and network parameters.

### BACKGROUND

Certain hardware environments, such as microcontrollers in control devices, require the creation of an adjusted executable program code to take into account the characteristics and limitations of the specific hardware environment. In particular, the available memory size of the working memory that the microcontroller may directly access may be limited, or memory shifting or copy operations from a flash or external memory to the working memory may be particularly complex due to hardware constraints.

The calculation steps for calculating corresponding layers of neural networks may require a significant amount of memory, as for each calculation layer, an input data block, a network parameter block, and an output data block must be retrieved and stored in the working memory in a form that can be used by the microcontroller.

During memory planning, existing code generators determine in which area of the working memory the data blocks required per calculation layer are stored in memory. During memory planning, in addition to mapping the input data blocks and output data blocks to memory areas, a corresponding memory area is also assigned to the data that arises during the calculation in a calculation layer.

Conventional code generators for neural networks typically assume that all input data blocks and output data blocks must be located in completely separate memory areas.

However, in conventional memory planning methods, no information about the type of calculation layer is included. Thus, it is not considered whether an output data block of a calculation step corresponds to a portion of an input data block of a subsequent calculation step. For example, this is the case with a calculation of a concatenation layer in which the concatenation interconnects two input data blocks.

In particular, copying memory areas from flash or external memory to working memory as well as between memory areas in the working memory, is generally a time-consuming memory operation, so memory planning must have the goal of reducing the processing time of memory operations.

It is the object of the present disclosure to provide improved memory management for the calculation of artificial neural networks in which the number of memory operations can be reduced.

### SUMMARY

This task is solved by the method for performing memory planning for code generation of a code for calculating a neural network according to the description set forth below as well as by the device also according to the description set forth below.

Further embodiments are specified in the description set forth below.

According to a first aspect, a computer-implemented method for performing memory planning for a code generation for determining a code for computing a neural network is provided, with the steps of:
providing successive calculation steps of the neural network, wherein the size of an input data block and an output data block is determined for each calculation step,
determining a condition for the memory planning for each specific computing step, in which an input data block in a memory area is at least partially contained in the output data block, wherein the condition indicates that the memory area associated with the output data block of the calculation step preceding the specific calculation step is contained in the memory area of the output data block of the specific calculation step;
performing memory planning in which the memory area of the respective input data block and output data block in the working memory is determined for each calculation step, taking into account the determined conditions.

In particular, performing the memory planning comprises applying an optimization method in which the target function takes into account minimizing the number of memory operations.

The individual calculation steps for calculating calculation layers of a neural network are typically calculated serially on a hardware environment. This means that the generated code specifies an order for the hardware environment in which the input data is processed and the output data of the respective calculation step is generated. Each calculation step takes the input data from one or more input data blocks and stores the resulting output data in one or more output data blocks. Input data blocks and output data blocks represent memory areas of a working memory corresponding to a contiguous address space.

The hardware environment includes a computing unit, a working memory, and a data store. A generated code for calculating a neural network is performed in the form of the calculation steps in the computing unit, wherein input data blocks and output data blocks in the working memory are used to provide the input data and store the output data. Access to data from the working memory has short access times, while access to the data store requires longer access times. The aim of memory planning is to reduce access times and the total calculation duration by providing and placing the input data blocks and output data blocks in the working memory, while at the same time taking into account or limiting the maximum available memory space of the working memory.

Depending on the calculation steps that need to be performed to calculate a neural network, there are often memory operations between the actual layer calculations that include copying or moving memory areas. The memory operations are often time-consuming and have a significant time portion that is not dependent on the size of the memory area to be copied or moved.

The above method provides for memory planning as part of a code generation for determining a code for calculating a neural network, for certain calculation steps, such as concatenation, slicing, and padding to position the output data block of the previous calculation step in the address range of the working memory such that a subsequent calculation step can be performed immediately by assigning an address pointer accordingly without the need for a memory operation, or such that only one memory operation must be performed with less effort.

Thus, a sequence of two calculation steps regarding the placement of the memory areas of the starting data block of the preceding calculation step and the memory area of the input data block of the subsequent calculation step can be optimized, such that no time consuming memory operation is necessary therebetween In particular, memory planning provides for placing the output block of data of a preceding calculation step, which is followed by the specific calculation step, in a memory area of the working memory, such that it can serve wholly or partially as the output data block for the specific calculation step. In other words, the input data block of the specific calculation step contains a part of the output data block that cannot be changed, in accordance with the memory planning specification, so that a memory operation is not necessary and only an address pointer needs to be used.

Memory planning may be performed in a manner known by a so-called SMT solver. This begins with a list of successive calculation steps defining the neural network and associated memory areas of the input data blocks and the output data blocks not yet associated with an address range in the working memory. These are determined only by their size. For each pair of two calculation steps, which are not necessarily consecutive, corresponding conditions are added to the SMT solver, specifying whether the output data block and the input data block should be positioned in the same address range.

As long as the calculation step does not involve concatenation, slicing or a padding, and the respective input data block can be stored line by line, the memory areas for the input data block and output data block of each calculation step must be stored separately.

It may be contemplated that, if the specific calculation step is a concatenation step, the condition indicates that one or more preceding calculation steps provide an output data block in a memory area that is immediately adjacent to a memory area with which the output data of the preceding calculation step is to be concatenated in the concatenation step..

It may be contemplated that, if the specific computing step is a padding step, the condition indicates that a preceding calculation step provides an output data block in a memory area that is directly adjacent to memory areas that are occupied by a padding pattern or are subsequently written with a padding pattern.

It may be contemplated that, if the specific computing step is a slicing step, the condition indicates that a preceding calculation step provides an output data block in a memory area that partially corresponds to the output data block of the specific calculation step.

If a specific calculation step is a concatenation, slicing or padding, an attempt is made to place the output data block for a preceding calculation step, such that corresponding further memory areas associated with the input data block of the specific calculation step are located immediately above or below (in the address space) the output data block of the preceding calculation step (concatenation).

In a specific calculation step corresponding to padding, memory areas occupied by a padding pattern are can be arranged above or below the output data block.

In a specific calculation step corresponding to slicing, a section of the relevant output data block from the preceding calculation step is assumed to be the input data block, which can be achieved by assigning the appropriate address and size. A copy operation is not necessary as the output data block corresponds to a portion of the input data block.

### BRIEF DESCRIPTION OF THE DRAWINGS

Preferred embodiments are described in more detail below with reference to the accompanying drawings. The figures show:

FIG. 1 a schematic illustration of a platform for code generation and implementation in a hardware environment;

FIG. 2 schematically shows a flowchart illustrating a method of memory planning for calculation steps including concatenation, slicing, or padding; and

FIGS. 3a and 3b schematic representations of a preferred memory planning for two successive calculation steps of a neural network without and with application of the method of FIG. 2.

### DETAILED DESCRIPTION

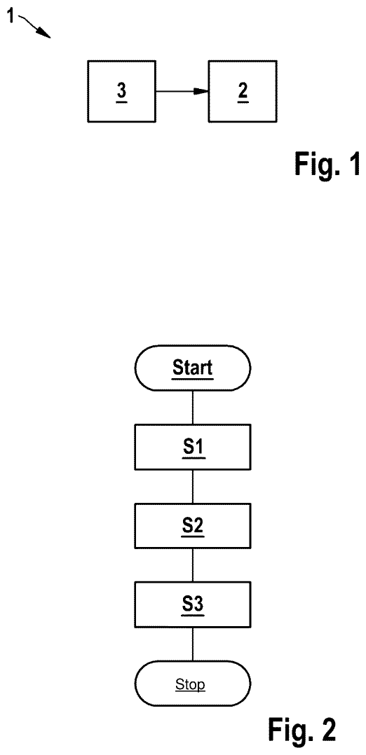

FIG. 1 shows a block diagram of a platform 1 for performing code generation and implementing a generated program code in a hardware environment 2. For example, the hardware environment corresponds to a control device having a microcontroller, microprocessor, or the like. Code generation is done on a conventional computer 3 or workstation based on the specified configuration of a neural network. Computer 3 is configured to perform memory planning and code generation, wherein memory planning initially performs a placement of memory areas for the individual calculation steps of the neural network for including at least one input data block and at least one output data block. The model parameter block comprises all model parameters needed for the calculation of the respective calculation step, e.g. weightings, bias values of a fully connected layer.

Once the code has been generated, it is transferred to the hardware environment 2, where it is implemented or executed.

As part of the method for memory planning described below, it may now be provided to place the memory ranges of input data blocks and output data blocks for calculation steps in the address range of the working memory, such that access is provided for the specific calculation step at least partially overlapping the memory range of an input data block for the calculation step. This can save a considerable amount of working memory storage space.

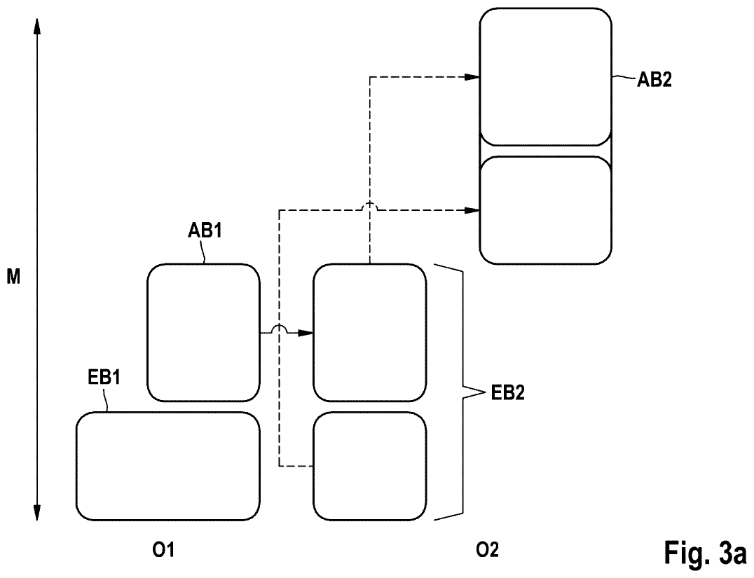

FIG. 2 schematically shows the sequence of memory planning using a SMT solver.

In step S1, successive calculation steps for calculating a neural network are first specified, each of which is associated with an input data block and an output data block as memory areas with defined sizes.

In step S2, specific calculation steps including a concatenation, slicing, or padding are identified. These specific calculation steps have the characteristic that at least portions of the output data block of a preceding calculation step are included in or completely correspond to the input data block.

Conditions for specific calculation steps can be derived from this for memory planning.

Conditions may be:

For a concatenation step, a preceding calculation step shall provide an output data block in a memory area that is directly adjacent to a memory area with which the output data of the preceding calculation step is to be connected..

For a padding step, a preceding calculation step shall provide an initial data block in a memory area that is immediately adjacent to memory areas that are occupied by a padding pattern or that can be written with a padding pattern.

For a slicing step, this should define the corresponding input data block in an address range that corresponds to the section of the output data to be selected in the output data block of the previous calculation step.

The remaining types of calculation steps are to place the memory areas for the input data block and the output data block into distinct memory areas.

Each memory area is assigned a service life that defines for how long, in particular, for what number of subsequent calculation steps, the data elements of the memory area may not be overwritten and thus indicate that the memory areas are occupied until they are no longer needed.

In step S3, memory planning is performed using an SMT solver. The objective of the optimization is to reduce the number of time-consuming memory operations.

For each calculation step preceding one of the above-mentioned calculation steps, the output data block is positioned in such a way that an addition to the data memory area associated with the specific calculation step is possible. This is the case for concatenation of a further memory area, which is to be connected to the memory area of the output data block of the preceding calculation step, or for padding, i.e. the attachment of a padding pattern above and below the memory area of the output data block of the preceding calculation step.

In the case of slicing, the input data block for the specific calculation step is defined as a subset of the memory area of the output data block of the preceding calculation step.

In particular, with limited working memory, it may not always be possible to optimize all specific calculation steps in the manner described above with respect to the number of memory operations. Therefore, an iterative optimization method can be performed with the SMT solver, which associates different memory areas of the output data block from the preceding calculation step to the determined calculation steps.

The best possible optimization is achieved when, for all specific calculation steps, the output data block from the preceding calculation step is written to a memory area of the working memory in such a way that no copy operation of the data from the output data block of the preceding calculation step is required in order to obtain the output data of the data from the output data block of the specified calculation step. For this purpose, only a corresponding address assignment (pointer) for defining the data of the output data block of the determined calculation step is to be carried out.

Next, memory planning is used to perform code generation.

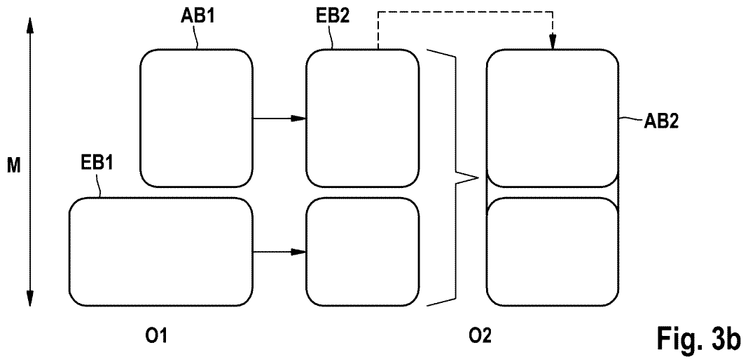

FIGS. 3a and 3b illustrate the positioning of the memory areas for the input and output data blocks EB1, EB2, AB1, AB2 in the case of a convolution layer, followed by a concatenation layer linking the input data block EB1. It can be seen in FIG. 3a that the output data block of the convolution layer supplements further input data for the concatenation layer, but another copy operation is performed to provide the output data block of the concatenation layer.

It is shown in FIG. 3b that the output data block AB1 of the convolution layer is completely within the address range of the memory range of the input data block EB2 of the concatenation layer and that no copying operation is necessary to provide the output data block AB2 as the input data block EB2 is part of the output data block AB2.

What is claimed is:

1. A computer-implemented method for performing memory planning for code generation for determining a code for calculating a neural network, comprising:
providing successive calculation steps of the neural network, wherein the size of an input data block and an output data block is determined for each calculation step;
determining a condition for the memory planning for each specific calculation step, in which an input data block in a memory area is at least partially contained in the output data block, wherein the condition specifies that the memory area associated with the output data block of the calculation step preceding the specific calculation step is contained in the memory area of the output data block of the specific calculation step; and
performing memory planning in which the memory area of the respective input data block and output data block in the working memory is determined for each calculation step, taking into account the determined conditions.

2. The method according to claim 1, wherein performing the memory planning comprises applying an optimization method in which the target function takes into account minimizing the number of memory operations.

3. The method according to claim 1, wherein the input data block and the output data block each specify or are associated with a memory area having successively ascending addresses.

4. The method according to claim 1, wherein, if the specific calculation step is a concatenation step, the condition specifies that a preceding calculation step provides an output data block in a memory area that is directly adjacent to a memory area with which the output data of the preceding calculation step is to be connected in the concatenation step.

5. The method according to claim 1, wherein, if the specific calculation step is a padding step, the condition specifies that a preceding calculation step provides an output data block in a memory area that is directly adjacent to memory areas that are occupied by a padding pattern or are subsequently written with a padding pattern.

6. The method according to claim 1, wherein, if the specific calculation step is a slicing step, the condition specifies that a preceding calculation step provides an output data block in a memory area that partially corresponds to the output data block of the specific calculation step.

7. The method according to claim 1, wherein code generation for the hardware environment is performed based on the result of the memory planning and implemented there.

8. A device for performing the method according to claim 1.

9. A computer program product comprising instructions which, when the program is executed by at least one data processing device, cause the data processing device to perform the steps of the method according to claim 1.

10. A machine-readable storage medium comprising commands which, when executed by at least one data processing device, cause the data processing device to perform the steps of the method according to claim 1.
